(19) United States
(12) Patent Application Publication
(10) Pub. No.: US 2013/0344350 A1
(43) Pub. Date: Dec. 26, 2013

(54) RECORDABLE OPTICAL RECORDING MEDIUM

(71) Applicant: Takuo Kodaira, Tokyo (JP)

(72) Inventor: Takuo Kodaira, Tokyo (JP)

(21) Appl. No.: 14/001,160

(22) PCT Filed: Feb. 9, 2012
(86) PCT No.: PCT/JP2012/052930

§ 371 Date: Sep. 6, 2013

(30) Foreign Application Priority Data
Feb. 24, 2011 (JP) 2011-038222

(51) Int. Cl. G11B 7/2467

(52) U.S. Cl. CPC G11B 7/2467
USPC 428/704

(57) ABSTRACT

A low-cost recordable optical recording medium is provided having a single-layered light transmission layer, and a recording layer containing an organic dye, the recordable optical recording medium showing a little asymmetry in the reproduction signal, and being capable of recording/reproducing data with light having a wavelength of 300 nm to 500 nm. A recordable optical recording medium including a substrate on which a reflective layer, a recording layer containing an organic dye, a protective layer, and a single-layered light transmission layer are laminated in the stated order, the recording layer being formed of the organic dye having a decomposition starting temperature of 240° C. or less.

### TECHNICAL FIELDS

The present invention relates to an LTH (Low to High) type recordable optical recording medium having a recording layer containing an organic dye and capable of recording/reproducing data with a light having a wavelength of 300 nm to 500 nm.

### BACKGROUND ART

As a recordable optical recording medium using an organic dye as a recording material, a CD-R having a recording capacity of 650 MB or 700 MB in a single layer, which records data using a laser beam having a wavelength of 780 nm and reproduces the recorded data, and a DVD-R/+R having a recording capacity of 4.7 GB in a single layer, which records data using a laser beam having a wavelength of 650 nm and reproduces the recorded data, have been widely used.

These recordable optical recording media are HTL (High to Low) type recordable optical recording media, which record data as a signal by using the reflectance that is high in the state of having recorded no data and is reduced after recording data.

In recent years, as a recordable optical recording medium having a large storage capacity, an HD DVD-R having a recording capacity of 15 GB in a single layer, which records data using a laser beam having a wavelength of 405 nm and reproduces the recorded data, has been commercialized. The HD DVD-R records data by the “On Groove” recording method in which a recording mark is formed in a concave portion of the groove as seen from the irradiation side of a laser beam, and is an LTH (Low to High) type recordable optical recording medium, which records data as a signal by using the reflectance that is low in the state of having recorded no data and is increased after recording data, as in the CD-R or DVD-R/+R.

Furthermore, an LTH (Low to High) type recordable optical recording medium having a recording capacity of 25 GB in a single layer, which uses an organic dye for a recording layer, records data using a laser having a wavelength of 405 nm, and reproduces the recorded data, has been developed.

This recordable optical recording medium records data by the “In Groove” recording method in which a recording mark is formed in a convex portion of the groove as seen from the irradiation side of a laser beam, and reproduces the recorded data. Because the recording position of the recording mark in the groove and the recording polarity in which the intensity of reflected light in an area of the recording layer having recorded data is higher than that in an area of the recording layer having recorded no data are different from those of the existing recordable optical recording medium, it is necessary to achieve a required performance by designing different recording materials.

In Japanese Patent Application Laid-open No. 2007-196661(Patent Document 1) or Japanese Patent Application Laid-open No. 2007-45147(Patent Document 2), as an organic dye suitable for forming a recording layer of an LTH (Low to High) type recordable optical recording medium, which records data using a laser beam having a wavelength of 405 nm and reproduces the recorded data, an azo metal complex having a specific structure has been proposed.

On the other hand, in order to form a short recording mark corresponding to a 2T signal or the like so as to have a desired length, the existing recordable optical recording medium having a recording layer formed of an organic dye has been configured to form a light transmissive light transmission layer having a thickness of about 0.1 mm by a material having a low modulus of elasticity of less than 40 MPa at a temperature of 25° C., and to significantly change the reflectance before and after recording data, by thermally decomposing an organic dye contained in an area of the recording layer irradiated with a laser beam and physically deforming an area of the light transmission layer adjacent to the area when recording data, thereby forming a short recording mark corresponding to a 2T signal or the like.

However, as described above, in the case where a light transmission layer is formed of a soft material having a low modulus of elasticity, because there are problems of degrading recording/reproduction properties due to an indentation caused by the external pressure in the light transmission layer, and of spoiling the appearance of the optical recording medium due to the damage on the surface of the light transmission layer caused by the external force, the light transmission layer has been formed to have a two-layered configuration, the outside layer of the light transmission layer has been formed of a hard material having a high modulus of elasticity, and the inside layer of the light transmission layer has been formed of a soft material having a low modulus of elasticity such as acrylic resin and an adhesive, in the past.
Patent Document 1: Japanese Patent Application Laid-open No. 2007-196661
Patent Document 2: Japanese Patent Application Laid-open No. 2007-45147
Patent Document 3: Japanese Patent Application Laid-open No. 2003-45079
Patent Document 4: Japanese Patent Application Laid-open No. 2003-36562
Patent Document 5: Japanese Patent Application Laid-open No. 2010-33667
Patent Document 6: Japanese Patent Application Laid-open No. 2009-26379
Patent Document 7: Japanese Patent Application Laid-open No. 2008-269703

### SUMMARY OF INVENTION

### Problem to be Solved by the Invention

As described above, the recordable optical recording medium including the light transmission layer having a two-layered configuration in which the inside layer of the light transmission layer is formed of a soft material having a low modulus of elasticity such as acrylic resin and an adhesive has an advantage that almost no stress is generated in the optical recording medium, because the deformation of the recording layer due to heat generation and expansion of the organic dye during data recording is absorbed by the inside layer of the light transmission layer.

However, if the light transmission layer has a two-layered configuration, which inevitably results in an increase in the number of production processes and hinders the cost reduction, the light transmission layer favorably has a single-layered configuration also in the recordable optical recording medium in which the recording layer is formed by using the organic dye, as in the recordable optical recording medium in which the recording layer is formed by using an inorganic material, and it is necessary to form the recording layer by using an organic dye having excellent recording/reproduction properties also in the case where the light transmission layer is formed to have a single-layered configuration.

As described above, in Japanese Patent Application Laid-open No. 2007-196661 (Patent Document 1) and Japanese Patent Application Laid-open No. 2007-45147 (Patent Document 2), as an organic dye suitable for forming the recording layer of the LTH (Low to High) type recordable optical recording medium, which records data using a laser having a wavelength of 405 nm and reproduces the recorded data, a specific azo metal complex has been proposed. However, in the case where a recording layer of an optical recording medium in which a reflective layer, the recording layer, and a single-layered light transmissive light transmission layer having a thickness of about 0.1 mm and formed of a material having a high modulus of elasticity are laminated on a surface of a resin substrate having a thickness of 1.1 mm on the irradiation side of a laser beam in the stated order, is formed by using such an organic dye, it cannot form a short recording mark corresponding to a 2T signal as desired or reproduce a signal with a little asymmetry, using a laser beam having a low recording power and a wavelength of 405 nm.

Here, the asymmetry in the reproduction signal represents the degree of deviation between the amplitude center of the reproduction signal reproduced from the smallest recording mark and the amplitude center of the reproduction signal reproduced from the largest recording mark, and is defined, in the case where the shortest reproduction signal is a 2T signal and the largest reproduction signal is an 8T signal, by an intensity I_{2H} of reflected light of a recording mark corresponding to the 2T signal, an intensity I_{2L} of reflected light of a land, an intensity I_{8H} of reflected light of a recording mark corresponding to the 8T signal, and an intensity I_{2L} of reflected light of a land, by the following formula.

Asymmetry=[(I_{8H}+I_{8L})−(I_{2H}+I_{2L})]/2/(I_{8H}−I_{8L})

Here, as shown in FIG. 1, I_{8H} represents the upper limit level of the 8T signal, I_{8L} represents the lower limit level of the 8T signal, I_{2H} represents the upper limit level of the 2T signal, and I_{2L} represents the lower limit level of the 2T signal (FIG. 1).

Therefore, it is an object of the present invention to provide a low-cost LTH (Low to High) type recordable optical recording medium having a single-layered light transmission layer, and a recording layer containing an organic dye, the recordable optical recording medium showing a little asymmetry in the reproduction signal, and being capable of recording/reproducing data with light having a wavelength of 300 nm to 500 nm.

### Means for Solving the Problem

In order to achieve such an object of the present invention, the inventor of the present invention has conducted intensive studies. As a result, it has been found that in the case where a decomposition starting temperature of the organic dye contained in the recording layer is 240° C. or less, the asymmetry in the reproduction signal is 15% or less even if a single-layered light transmission layer is formed of a hard material having a high modulus of elasticity of 40 MPa or more at a temperature of 25° C., and that it is possible to reduce the number of production processes to reduce the cost of the recordable optical recording medium by forming the light transmission layer to have a single-layered configuration.

The present invention is based on such findings, and the above-mentioned object of the present invention is achieved by a recordable optical recording medium including a substrate on which at least a reflective layer, a recording layer containing an organic dye, and a single-layered light transmission layer are laminated, characterized in that the organic dye has a decomposition starting temperature of 240° C. or less.

In the present specification, the decomposition starting temperature of the organic dye represents a temperature in which a difference TG between the weight of a sample and the weight of a reference, which are measured by a TG-DTA (thermogravimetric differential thermal analysis) method, is significantly decreased.

In the case where the recording layer is composed of the organic dye having a decomposition starting temperature of 240° C. or less, although the reason why the asymmetry in the reproduction signal can be reduced even if the light transmission layer is formed to have a single-layered configuration is not necessarily clear, it can be presumed as follows.

That is, in the optical recording medium whose recording layer is formed of an organic dye, if a laser beam for recording is applied to the recording layer, the organic dye contained in the recording layer absorbs the laser beam and converts optical energy into thermal energy, which generates heat. The heat generated at this time causes the organic dye to be thermally decomposed, and changes the optical properties of the organic dye contained in a portion of the recording layer, which is irradiated with the laser beam, and thus a recording mark is formed. As a result, the reflectance of an area of the recording layer, which is irradiated with the laser beam, is increased to make a difference between the reflectance of the area of the recording layer, which is irradiated with the laser beam, and the reflectance of an area of the recording layer, which is not irradiated with a laser beam, and thus data is recorded in the optical recording medium. Because the length of the recording mark to be formed depends on the irradiation time of a laser beam, it is necessary to shorten the irradiation time of a laser beam to form a short recording mark corresponding to a 2T signal or the like. However, if the irradiation time of a laser beam is shortened, the laser beam is not applied during the stage in which the temperature of the organic dye does not reach the thermal decomposition temperature, i.e., decomposition starting temperature, a short recording mark cannot be formed as desired, and the asymmetry in the reproduction signal is increased, in some cases. In the case where the recording layer is formed of an organic dye having a low decomposition starting temperature, even if the irradiation time of a laser beam is shortened, the temperature of the organic dye contained in the area of the recording layer, which is irradiated with the laser beam, reaches the decomposition starting temperature while the laser beam is being applied, the organic dye is thermally decomposed, and thus it is possible to form a recording mark having a desired length and to reduce the asymmetry in the reproduction signal.

In the present invention, as the organic dye having a decomposition starting temperature of 240° C. or less, a metal complex compound configured by bonding an azo compound having a specific structure represented by the following general formula (1) or (2) to a metal ion to form a coordinate bond is favorably used.

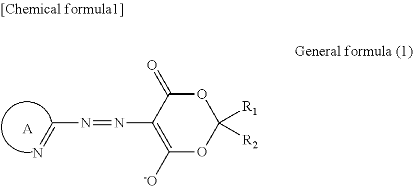

In the general formula (1), a nucleus A represents a nitrogen-containing heteroaromatic ring, and R1 and R2 each represent an alkyl group that may be substituted, which has 1 to 10 carbon atoms, and may form a linear alkyl group, a branched alkyl group, or a cyclic structure.

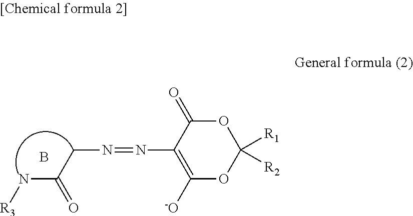

In the general formula (2), a nucleus B represents a nitrogen-containing heteroaromatic ring, R1 and R2 each represent an alkyl group that may be substituted, which has 1 to 10 carbon atoms, and may form a linear alkyl group, a branched alkyl group, or a cyclic structure, and R3 represents an aromatic group or an alkyl group having 1 to 6 carbon atoms, and may form a linear alkyl group, a branched alkyl group, or a cyclic structure.

In the present invention, the metal ion to which the azo compound having a specific structure represented by the general formula (1) or (2) is coordinated is favorably selected from the group consisting of nickel, cobalt, and copper.

In the present invention, the nucleus A being a nitrogen-containing heteroaromatic ring in the formula (1) is more favorably selected from the group consisting of nitrogen-containing heteroaromatic rings represented by the following structural formulae (11) to (24). In the structural formulae (13) to (24), R4 and R5 each represent a hydrogen atom, an alkyl group having 1 to 6 carbon atoms, a benzyl group, alkoxy group having 1 to 4 carbon atoms, or a thioalkyl group having 1 to 4 carbon atoms, and the alkyl group may form a linear alkyl group, a branched alkyl group, or a cyclic structure.

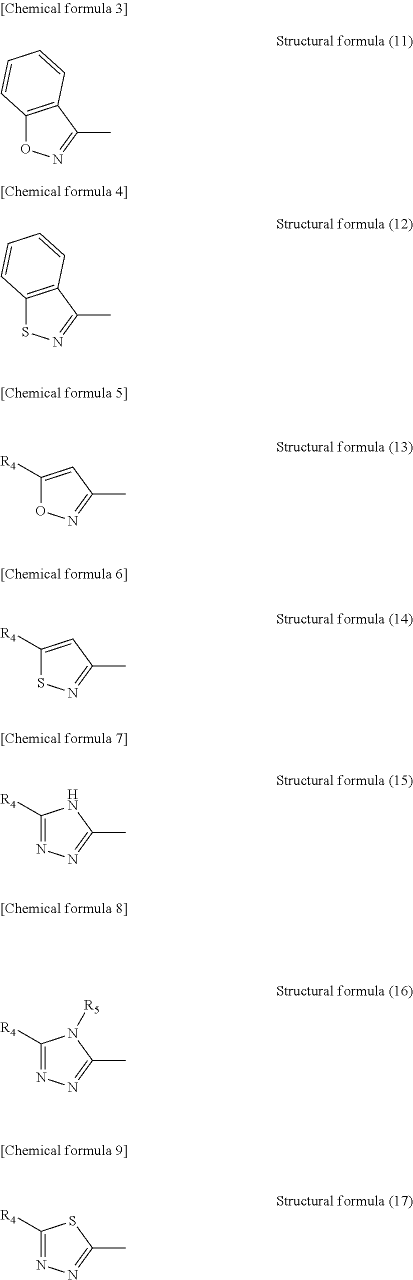

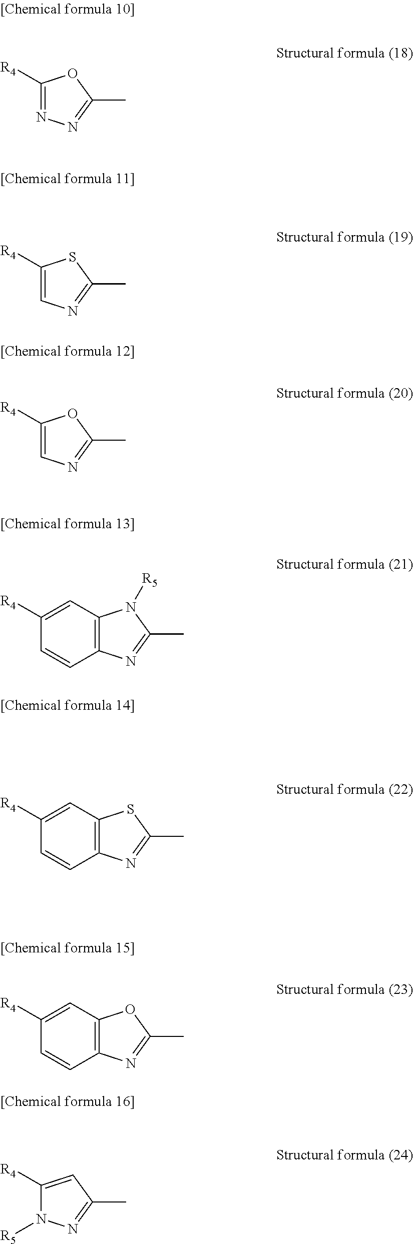

In the present invention, the nucleus B being a nitrogen-containing heteroaromatic ring in the formula (2) more favorably has a structure represented by the following structural formula (25):

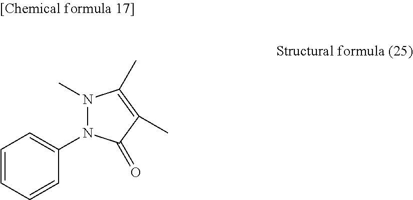

In the present invention, the single-layered light transmission layer is favorably formed of photo-curable resin having a modulus of elasticity of 10 MPa or more at a temperature of 25° C., and is more favorably formed of photo-curable resin having a modulus of elasticity of 40 MPa to 10000 MPa or more at a temperature of 25° C.

In the present invention, the recordable optical recording medium favorably further includes a protective layer formed of a dielectric material between the recording layer and the light transmission layer.

In the present invention, the recordable optical recording medium favorably further includes a hard coating layer on a surface of the light transmission layer, the surface being opposite to the recording layer.

### Effect of the Invention

According to the present invention, it is possible to provide a low-cost LTH (Low to High) type recordable optical recording medium having a single-layered light transmission layer, and a recording layer containing an organic dye, the recordable optical recording medium showing a little asymmetry in reproduction signal, and being capable of recording/reproducing data with light having a wavelength of 300 nm to 500 nm.

### BRIEF DESCRIPTION OF THE DRAWINGS

FIG. 1 is a diagram showing an intensity I_{2H} of reflected light of a recording mark corresponding to the 2T signal, an intensity I_{2L} of reflected light of a land, an intensity I_{8H} of reflected light of a recording mark corresponding to the 8T signal, and an intensity I_{2L} of reflected light of a land.

FIG. 2 is a schematic vertical cross-sectional view of a recordable optical recording medium according to a preferred embodiment of the present invention.

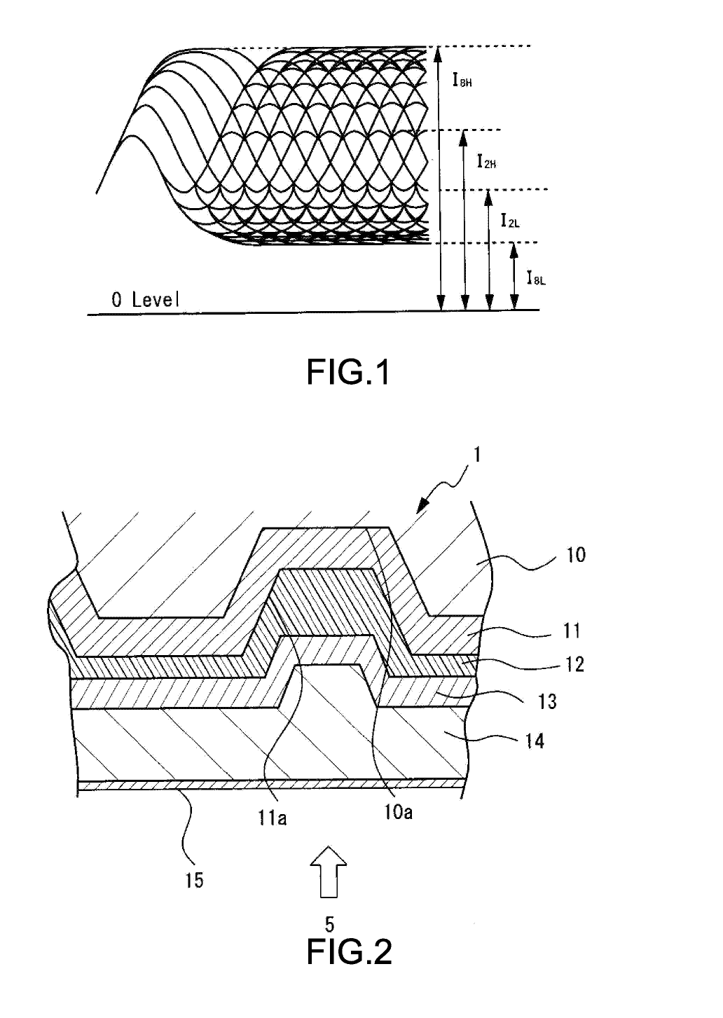

### MODE(S) FOR CARRYING OUT THE INVENTION

FIG. 2 is a schematic vertical cross-sectional view of an LTH (Low to High) type recordable optical recording medium according to a preferred embodiment of the present invention.

As shown in FIG. 2, an LTH (Low to High) type recordable optical recording medium 1 according to this embodiment includes a substrate 10, and a reflective layer 11, a recording layer 12, a protective layer 13, a light transmissive light transmission layer 14, and a hard coating layer 15 are laminated on the substrate 10 in the stated order.

In this embodiment, the recordable optical recording medium 1 is configured to record data by a laser beam 5 having a wavelength of 405 nm, and to reproduce the recorded data. The recording laser beam 5 for recording data in the recording layer 12 of the recordable optical recording medium 1, and the reproducing laser beam 5 for reproducing the data recorded in the recording layer 12 are configured to be applied to the outer surface of the hard coating layer 15.

Although not shown in FIG. 2, the LTH (Low to High) type recordable optical recording medium 1 according to this embodiment has a circular plate shape, and a center hole is formed at the center portion.

The substrate 10 has a circular plate shape, functions as a supporting body for ensuring mechanical strength required for the recordable optical recording medium 1, has a thickness of about 1.1 mm, and has a diameter of 120 mm.

The material for forming the substrate 10 is not particularly limited as long as mechanical strength required for the recordable optical recording medium 1 can be ensured, and the substrate 10 can be formed by metal such as aluminum, glass, ceramic, resin, or the like. Among these, resin, particularly, thermoplastic resin is favorably used, from viewpoints of formability, resistance to humidity, dimensional stability, cost, and the like. Examples of resin for forming the substrate 10 include polycarbonate resin, acrylic resin such as polymethyl methacrylate, vinyl chloride resin such as polyvinyl chloride and a vinyl chloride copolymer, epoxy resin, amorphous polyolefin resin, and polyester resin. Among these, polycarbonate resin is particularly favorable.

As shown in FIG. 2, on the surface of the substrate 10, a helical guide groove 10a is formed. The helical guide groove 10a can be formed by, for example, injection molding of the substrate 10 using a mold in which a stamper is set. Favorably, the guide groove 10a is formed so as to have a pitch of 0.35 μm or 0.32 μm, the width of the guide groove 10a is set to 160 nm to 200 nm, and the depth of the guide groove 10a is 30 nm to 45 nm. Here, the width of the guide groove 10a is represented by a full width at half maximum at the position where the depth of the width of the guide groove 10a becomes half.

As shown in FIG. 2, on the surface of the substrate 10 on the side of the guide groove 10a formed, the reflective layer 11 is formed by sputtering or the like. The reflective layer 11 has a function to reflect the laser beam 5, which is applied to the optical recording medium 1 and is transmitted through the recording layer 12, to the recording layer 12, and is normally formed of metal having a high reflectance, such as an Ag alloy and an Al alloy. In this embodiment, the reflective layer 11 is formed of an Ag alloy. The reflective layer 11 is favorably formed so as to have a thickness of 40 nm to 65 nm.

Because the reflective layer 11 is formed on the surface of the substrate 10 on the side of the helical guide groove 10a formed, also in the reflective layer 11, a guide groove 11a is formed. Favorably, the width of the guide groove 11a formed in the reflective layer 11 is 150 nm to 190 nm, and the depth of the guide groove 11a is 30 nm to 45 nm.

As shown in FIG. 2, on the surface of the reflective layer 11, the recording layer 12 is formed, and the recording layer 12 includes an organic dye. The recording layer 12 is formed by applying a solution containing an organic dye to the surface of the reflective layer 11 by spin coating to form a coating film, and drying the coating film.

In this embodiment, the organic dye contained in the recording layer 12 has a decomposition starting temperature of 240° C. or less.

Here, the decomposition starting temperature of the organic dye is measured by a TG-DTA (thermogravimetric differential thermal analysis) method.

That is, a sample is obtained by putting about 3 mg of organic dye weighed by a precision balance in a platinum pan. Similarly, a reference is obtained by putting about 3 mg of alumina (Al₂O₃) weighed by a precision balance in a platinum pan. A nitrogen gas is flown at a flow rate of 200 ml per minute, the sample and reference are heated at a rate of temperature increase of 10° C. per minute in the atmosphere, the weights of the sample and reference are measured by drive coils separately sensitivity-adjusted using a thermogravimetric differential thermal analyser “TGDTA-2000SR” (trade name) manufactured by Bruker AXS K.K., a difference TG between the weight of the sample and the weight of the reference is determined, and a temperature in which TG is significantly decreased is determined as a decomposition starting temperature of the organic dye.

As the organic dye having a decomposition starting temperature of 240° C. or less, an organic dye represented by the general formula (1) in which the nucleus A being a nitrogen-containing heteroaromatic ring is selected from the group consisting of nitrogen-containing heteroaromatic rings represented by the structural formulae (11) to (24) is favorably used.

Moreover, as the organic dye having a decomposition starting temperature of 240° C. or less, an organic dye represented by the general formula (2) in which the nucleus B being a nitrogen-containing heteroaromatic ring have a structure represented by the structural formula (25) is favorably used.

In this embodiment, as the organic dye, an organic dye represented by the following structural formula (31) is used.

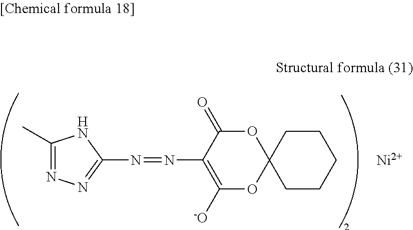

In this embodiment, the recording layer 12 is formed by dissolving the organic dye represented by the structural formula (31) in, for example, 2,2,3,3-tetrafluoro-1-propanol (TFP), applying the organic material solution thus obtained to the surface of the reflective layer 11 by a spin coating method so that the optical density (OD value) of the recording layer 12 becomes an optical density (OD value) at the time when the value of DC jitter is the lowest, and drying it.

Here, the optical density (OD value) represents the absorbance in the maximum absorbing wavelength of the organic dye, and is determined by applying a solution containing the organic dye to the surface of the substrate to form the recording layer, and measuring the absorbance using light having the maximum absorbing wavelength of the organic dye. The optical density (OD value) can be adjusted with deposition conditions of the recording layer 12 such as a ration rate of the substrate 10 and a time period in a spin coating method. The optical density (OD value) at the time when the DC jitter is the lowest is determined by changing the deposition conditions, preparing a plurality of samples in which the recording layers 12 having different optical densities (OD values) are formed, using, for example, a data recording/reproducing apparatus “ODU-1000” (trade name) manufactured by Pulstec Industrial Co., Ltd. to record data in the recording layer of the prepared sample and reproduce the recorded data, and measuring the DC jitter of the reproduction signal.

As shown in FIG. 2, on the surface of the recording layer 12, the protective layer 13 is formed.

The protective layer 13 has a function to prevent the organic dye contained in the recording layer 12 from diffusing through the light transmission layer 14 when forming the light transmission layer 14 and to prevent a mixing phenomenon in which a solvent of photo-curable resin used when forming the light transmission layer 14 permeates through the recording layer 12.

The material capable of forming the protective layer 13 is not particularly limited as long as it is a transparent dielectric material. Example of such material include oxides such as silicon oxide (more favorably silicon dioxide), zinc oxide, cerium oxide, yttrium oxide, indium oxide-tin oxide (ITO), sulfides such as zinc sulfide and zinc yttrium, nitride such as silicon nitride, silicon carbide, and a mixture of an oxide and a sulphur compound. In this embodiment, the protective layer 13 is formed of indium oxide-tin oxide (ITO) and formed by sputtering or the like.

As shown in FIG. 2, on the surface of the protective layer 13, the light transmission layer 14 is formed.

The light transmission layer 14 is formed by applying photo-curable resin cured by being irradiated with ultraviolet rays or radiation to the surface of the protective layer 13 by a spin coating method to form a coating film, and applying ultraviolet rays or radiation to the coating film to cure the coating film.

In this embodiment, the thickness of the light transmission layer 14 is set so that the sum of the thickness of the light transmission layer 14 and the thickness of the hard coating layer 15 formed on the light transmission layer 14 is 100 μm.

The light transmission layer 14 has light transmittance to light having wavelength of 405 nm of 70% or more, favorably 80% or more, which is measured by a spectrophotometer with light having a wavelength of 405 nm.

In the present invention, the light transmission layer 14 is favorably formed of photo-curable resin having a modulus of elasticity of 10 MPa or more at a temperature of 25° C. after being cured, and in this embodiment, the light transmission layer 14 is formed of photo-curable resin having a modulus of elasticity of 40 MPa to 10000 MPa at a temperature of 25° C. after being cured.

As shown in FIG. 2, on the surface of the light transmission layer 14, the hard coating layer 15, which physically protects the light transmission layer 14 and prevents the light transmission layer 14 from being scratched, is formed.

The material for forming the hard coating layer 15 is not particularly limited. However, a material having excellent transparency and resistance to attrition is favorable, and the hard coating layer 15 is favorably formed by applying a resin composition, which is obtained by adding inorganic particles to ultraviolet curable resin, to the surface of the light transmission layer 14 by a spin coating method.

The thickness of the hard coating layer 15 is favorably 1 μm to 5 μm.

When data is recorded in the optical recording medium 1 configured as described above, the laser beam 5 having a wavelength of 350 nm to 500 m is applied to the outer surface of the hard coating layer 15.

The laser beam 5 transmits through the hard coating layer 15, the light transmission layer 14, and the protective layer 13 to be incident on the recording layer 12, or transmits through the recording layer 12 and is reflected by the reflective layer 11 to be incident on the recording layer 12.

As a result, the organic dye contained in the area of the recording layer 12, which is irradiated with the laser beam 5, is thermally decomposed, and the reflectance of the area is increased. Thus, a recording mark is formed, and data is written in the optical recording medium 1.

In this embodiment, because the recording layer 12 is formed of an organic dye having a decomposition starting temperature of 240° C. or less, in the case where the irradiation time of the laser beam 5 is shortened to form a short recording mark corresponding to a 2T signal or the like, the organic dye contained in the area of the recording layer 12, which is irradiated with the laser beam 5, is rapidly heated to a temperature higher than the decomposition starting temperature while the laser beam 5 is being applied, and is decomposed. Therefore, it is possible to form a short recording mark corresponding to a 2T signal or the like, as desired. Thus, it is possible to reduce the asymmetry in the reproduction signal.

### EXAMPLE

Hereinafter, in order to make the effect of the invention more clear, examples and comparative examples will be described.

### Example 1

A substrate made of polycarbonate resin, which includes a center hole at the center portion and a guide groove having a track pitch of 0.32 μm, a groove width of 180 nm, and a groove depth of 32 nm, and has an outer diameter of 120 mm, a thickness of 1.1 mm, and a circular plate shape, was prepared by injection molding.

On the surface of the substrate on the side of the guide groove formed, a reflective layer formed of an Ag alloy, which has a thickness of 60 nm, was formed by sputtering.

Furthermore, a recording layer was formed by dissolving an organic dye having the structure represented by the structural formula (31) in 2,2,3,3-tetrafluoro-1-propanol (TFP), applying the organic dye solution thus obtained to the surface of the reflective layer by a spin coating method to form a coating film, and drying the coating film at a temperature of 80° C. for 10 minutes so that the optical density (OD value) became 0.25 at the absorption maximum wavelength (λmax=379 nm). The decomposition starting temperature of the organic dye having a structure represented by the structural formula (31) was 184° C.

Next, on the upper surface of the recording layer, a transparent protective layer having a thickness of 20 nm was formed by sputtering of ZnS—SiO₂.

Furthermore, a light transmission layer having a thickness of 97 μm was formed by applying ultraviolet curable resin to the surface of the protective layer by a spin coating method to form a coating film, and applying ultraviolet rays to cure the coating film. The modulus of elasticity of the light transmission layer after being cured at a temperature of 25° C. was 2300 MPa. For the measurement of the modulus of elasticity, a dynamic viscoelasticity measuring apparatus RMA III manufactured by TA Instruments Japan Inc. was used. As a specimen, 100 μm of sample resin was applied to a disc, the resin was removed from the disc after being cured, the resin was cut into 5 mm×50 mm slices, and the cut resin was used.

Next, a hard coating layer having a thickness of 3 μm was formed by applying a resin composition, which is obtained by adding inorganic particles to ultraviolet curable resin, to the surface of the light transmission layer by a spin coating method to form a coating film, and applying ultraviolet rays to the coating film to cure the coating film.

Thus, an optical recording medium sample #1 was prepared.

Next, the optical recording medium sample #1 is set in a data recording/reproducing apparatus “ODU-1000” (trade name) manufactured by Pulstec Industrial Co., Ltd., and data was recorded by applying a laser beam having a wavelength of 405 nm to the recording layer using an objective lens having an NA of 0.85 through the light transmission layer while changing the power of the laser beam and rotating the optical recording medium sample #1 at a linear velocity of 19.68 m/sec (4× recording speed)

A recording signal of the data recorded in the optical recording medium sample #1 in this way was reproduced using the above-mentioned data recording/reproducing apparatus, and the reproduction properties were evaluated. The power of the laser beam (optimal laser power) where a DC jitter of the reproduction signal became the smallest was 8.6 mW.

Next, the data recorded in the optical recording medium sample #1 was reproduced using the above-mentioned data recording/reproducing apparatus by fixing the power of the laser beam to 0.35 mW, and the reproduction signal was evaluated. The DC jitter was 7.7%, the degree of modulation was 45%, the asymmetry was 4.2%, and it was found that the optical recording medium sample #1 was capable of recording data with a low laser beam power and had favorable recording properties, i.e., the high degree of modulation and a little asymmetry.

### Example 2

An optical recording medium sample #2 was prepared in the same way as that in Example 1 except that instead of the organic dye having the structure represented by the structural formula (31), an organic dye having the structure represented by the following structural formula (32) and a decomposition starting temperature of 214° C. was used.

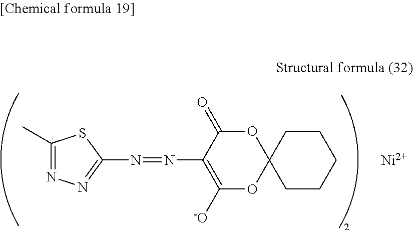

The absorption maximum wavelength λmax of the optical recording medium sample #2 was 420 nm, and the OD value was 0.23.

The optical recording medium sample #2 prepared in this way was set in the data recording/reproducing apparatus used in Example 1, data was recorded, and the data was reproduced in the same way as that in Example 1. The optimal laser beam power was 9.2 mW.

Next, the data recorded in the optical recording medium sample #2 was reproduced using the above-mentioned data recording/reproducing apparatus by fixing the power of the laser beam to 0.35 mW, and the reproduction signal was evaluated. The DC jitter was 9.2%, the degree of modulation was 48%, and the asymmetry was 7.8%.

### Example 3

An optical recording medium sample #3 was prepared in the same way as that in Example 1 except that instead of the organic dye having the structure represented by the structural formula (31), an organic dye having the structure represented by the following structural formula (33) and a decomposition starting temperature of 175° C. was used.

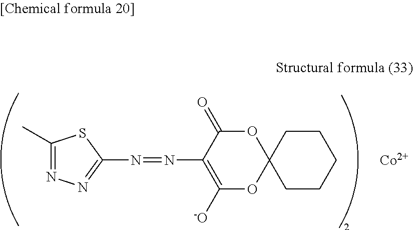

The absorption maximum wavelength λmax of the optical recording medium sample #3 was 375 nm, and the OD value was 0.25.

The optical recording medium sample #3 prepared in this way was set in the data recording/reproducing apparatus used in Example 1, data was recorded, and the data was reproduced in the same way as that in Example 1. The optimal laser beam power was 9.8 mW.

Next, the data recorded in the optical recording medium sample #3 was reproduced using the above-mentioned data recording/reproducing apparatus by fixing the power of the laser beam to 0.35 mW, and the reproduction signal was evaluated. The DC jitter was 9.5%, the degree of modulation was 46%, and the asymmetry was 9.5%.

### Example 4

An optical recording medium sample #4 was prepared in the same way as that in Example 1 except that instead of the organic dye having the structure represented by the structural formula (31), an organic dye having the structure represented by the following structural formula (34) and a decomposition starting temperature of 159° C. was used.

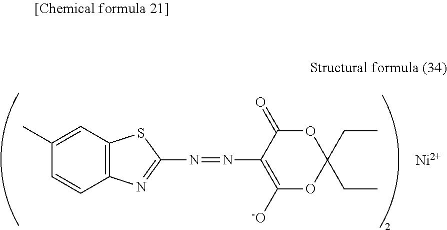

The absorption maximum wavelength λmax of the optical recording medium sample #4 was 446 nm, and the OD value was 0.30.

The optical recording medium sample #4 prepared in this way was set in the data recording/reproducing apparatus used in Example 1, data was recorded, and the data was reproduced in the same way as that in Example 1. The optimal laser beam power was 8.2 mW.

Next, the data recorded in the optical recording medium sample #4 was reproduced using the above-mentioned data recording/reproducing apparatus by fixing the power of the laser beam to 0.35 mW, and the reproduction signal was evaluated. The DC jitter was 9.9%, the degree of modulation was 40%, and the asymmetry was 4.8%.

### Example 5

An optical recording medium sample #5 was prepared in the same way as that in Example 1 except that instead of the organic dye having the structure represented by the structural formula (31), an organic dye having the structure represented by the following structural formula (35) and a decomposition starting temperature of 178° C. was used.

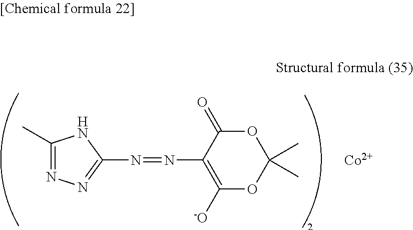

The absorption maximum wavelength λmax of the optical recording medium sample #5 was 370 nm, and the OD value was 0.25.

The optical recording medium sample #5 prepared in this way was set in the data recording/reproducing apparatus used in Example 1, data was recorded, and the data was reproduced in the same way as that in Example 1. The optimal laser beam power was 8.6 mW.

Next, the data recorded in the optical recording medium sample #5 was reproduced using the above-mentioned data recording/reproducing apparatus by fixing the power of the laser beam to 0.35 mW, and the reproduction signal was evaluated. The DC jitter was 8.2%, the degree of modulation was 45%, and the asymmetry was 3.8%.

### Example 6

An optical recording medium sample #6 was prepared in the same way as that in Example 1 except that instead of the organic dye having the structure represented by the structural formula (31), an organic dye having the structure represented by the following structural formula (36) and a decomposition starting temperature of 185° C. was used.

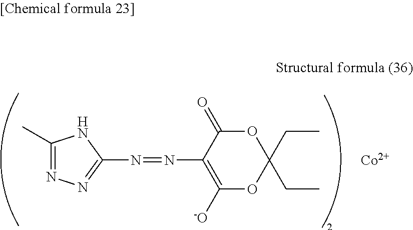

The absorption maximum wavelength λmax of the optical recording medium sample #6 was 373 nm, and the OD value was 0.25.

The optical recording medium sample #6 prepared in this way was set in the data recording/reproducing apparatus used in Example 1, data was recorded, and the data was reproduced in the same way as that in Example 1. The optimal laser beam power was 9.0 mW.

Next, the data recorded in the optical recording medium sample #6 was reproduced using the above-mentioned data recording/reproducing apparatus by fixing the power of the laser beam to 0.35 mW, and the reproduction signal was evaluated. The DC jitter was 8.4%, the degree of modulation was 48%, and the asymmetry was 6.0%.

### Example 7

An optical recording medium sample #7 was prepared in the same way as that in Example 1 except that instead of the organic dye having the structure represented by the structural formula (31), an organic dye having the structure represented by the following structural formula (37) and a decomposition starting temperature of 168° C. was used.

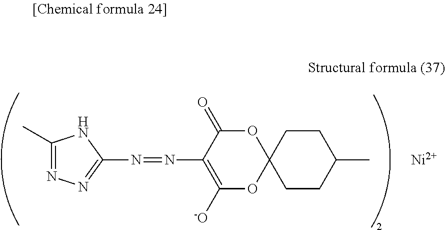

The absorption maximum wavelength λmax of the optical recording medium sample #7 was 379 nm, and the OD value was 0.25.

The optical recording medium sample #7 prepared in this way was set in the data recording/reproducing apparatus used in Example 1, data was recorded, and the data was reproduced in the same way as that in Example 1. The optimal laser beam power was 8.7 mW.

Next, the data recorded in the optical recording medium sample #7 was reproduced using the above-mentioned data recording/reproducing apparatus by fixing the power of the laser beam to 0.35 mW, and the reproduction signal was evaluated. The DC jitter was 8.1%, the degree of modulation was 44%, and the asymmetry was 4.5%.

### Example 8

An optical recording medium sample #8 was prepared in the same way as that in Example 1 except that instead of the organic dye having the structure represented by the structural formula (31), an organic dye having the structure represented by the following structural formula (38) and a decomposition starting temperature of 170° C. was used.

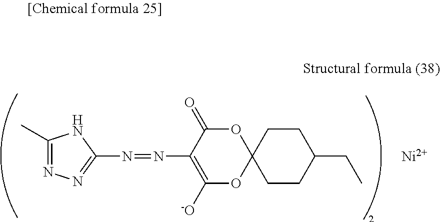

The absorption maximum wavelength λmax of the optical recording medium sample #8 was 383 nm, and the OD value was 0.25.

The optical recording medium sample #8 prepared in this way was set in the data recording/reproducing apparatus used in Example 1, data was recorded, and the data was reproduced in the same way as that in Example 1. The optimal laser beam power was 8.7 mW.

Next, the data recorded in the optical recording medium sample #8 was reproduced using the above-mentioned data recording/reproducing apparatus by fixing the power of the laser beam to 0.35 mW, and the reproduction signal was evaluated. The DC jitter was 8.1%, the degree of modulation was 48%, and the asymmetry was 4.4%.

### Example 9

An optical recording medium sample #9 was prepared in the same way as that in Example 1 except that instead of the organic dye having the structure represented by the structural formula (31), an organic dye having the structure represented by the following structural formula (39) and a decomposition starting temperature of 175° C. was used.

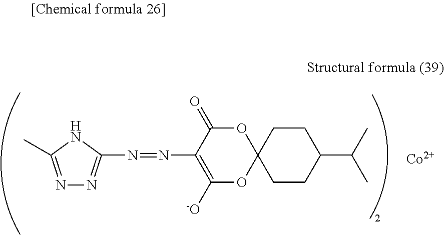

The absorption maximum wavelength λmax of the optical recording medium sample #9 was 374 nm, and the OD value was 0.25.

The optical recording medium sample #9 prepared in this way was set in the data recording/reproducing apparatus used in Example 1, data was recorded, and the data was reproduced in the same way as that in Example 1. The optimal laser beam power was 8.6 mW.

Next, the data recorded in the optical recording medium sample #9 was reproduced using the above-mentioned data recording/reproducing apparatus by fixing the power of the laser beam to 0.35 mW, and the reproduction signal was evaluated. The DC jitter was 7.9%, the degree of modulation was 50%, and the asymmetry was 2.8%.

### Example 10

An optical recording medium sample #10 was prepared in the same way as that in Example 1 except that instead of the organic dye having the structure represented by the structural formula (31), an organic dye having the structure represented by the following structural formula (40) and a decomposition starting temperature of 181° C. was used.

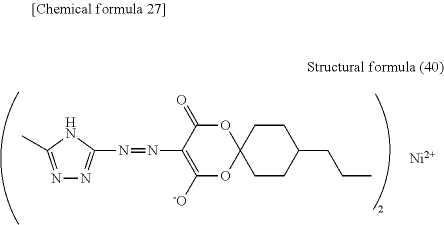

The absorption maximum wavelength λmax of the optical recording medium sample #10 was 383 nm, and the OD value was 0.25.

The optical recording medium sample #10 prepared in this way was set in the data recording/reproducing apparatus used in Example 1, data was recorded, and the data was reproduced in the same way as that in Example 1. The optimal laser beam power was 8.9 mW.

Next, the data recorded in the optical recording medium sample #10 was reproduced using the above-mentioned data recording/reproducing apparatus by fixing the power of the laser beam to 0.35 mW, and the reproduction signal was evaluated. The DC jitter was 7.8%, the degree of modulation was 47%, and the asymmetry was 3.8%.

### Example 11

An optical recording medium sample #11 was prepared in the same way as that in Example 1 except that instead of the organic dye having the structure represented by the structural formula (31), an organic dye having the structure represented by the following structural formula (41) and a decomposition starting temperature of 196° C. was used.

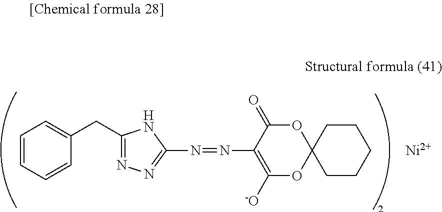

The absorption maximum wavelength λmax of the optical recording medium sample #11 was 381 nm, and the OD value was 0.25.

The optical recording medium sample #11 prepared in this way was set in the data recording/reproducing apparatus used in Example 1, data was recorded, and the data was reproduced in the same way as that in Example 1. The optimal laser beam power was 8.4 mW.

Next, the data recorded in the optical recording medium sample #11 was reproduced using the above-mentioned data recording/reproducing apparatus by fixing the power of the laser beam to 0.35 mW, and the reproduction signal was evaluated. The DC jitter was 8.7%, the degree of modulation was 52%, and the asymmetry was 5.8%.

### Example 12

An optical recording medium sample #12 was prepared in the same way as that in Example 1 except that instead of the organic dye having the structure represented by the structural formula (31), an organic dye having the structure represented by the following structural formula (42) and a decomposition starting temperature of 188° C. was used.

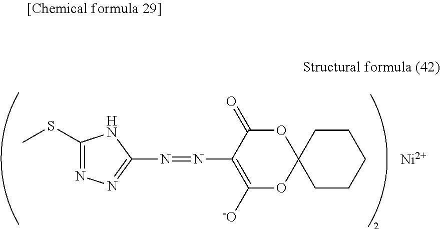

The absorption maximum wavelength λmax of the optical recording medium sample #12 was 391 nm, and the OD value was 0.25.

The optical recording medium sample #12 prepared in this way was set in the data recording/reproducing apparatus used in Example 1, data was recorded, and the data was reproduced in the same way as that in Example 1. The optimal laser beam power was 8.0 mW.

Next, the data recorded in the optical recording medium sample #12 was reproduced using the above-mentioned data recording/reproducing apparatus by fixing the power of the laser beam to 0.35 mW, and the reproduction signal was evaluated. The DC jitter was 9.0%, the degree of modulation was 49%, and the asymmetry was 4.2%.

### Example 13

An optical recording medium sample #13 was prepared in the same way as that in Example 1 except that instead of the organic dye having the structure represented by the structural formula (31), an organic dye having the structure represented by the following structural formula (43) and a decomposition starting temperature of 191° C. was used.

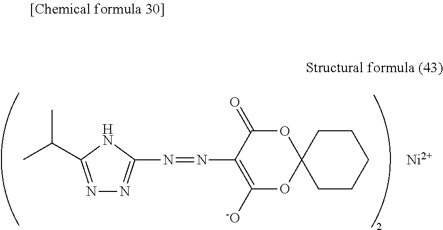

The absorption maximum wavelength λmax of the optical recording medium sample #13 was 385 nm, and the OD value was 0.25.

The optical recording medium sample #13 prepared in this way was set in the data recording/reproducing apparatus used in Example 1, data was recorded, and the data was reproduced in the same way as that in Example 1. The optimal laser beam power was 8.5 mW.

Next, the data recorded in the optical recording medium sample #13 was reproduced using the above-mentioned data recording/reproducing apparatus by fixing the power of the laser beam to 0.35 mW, and the reproduction signal was evaluated. The DC jitter was 8.6%, the degree of modulation was 48%, and the asymmetry was 3.5%.

### Example 14

An optical recording medium sample #14 was prepared in the same way as that in Example 1 except that instead of the organic dye having the structure represented by the structural formula (31), an organic dye having the structure represented by the following structural formula (44) and a decomposition starting temperature of 175° C. was used.

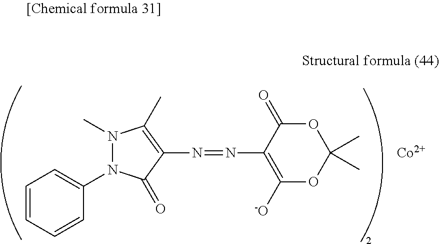

The absorption maximum wavelength λmax of the optical recording medium sample #14 was 398 nm, and the OD value was 0.22.

The optical recording medium sample #14 prepared in this way was set in the data recording/reproducing apparatus used in Example 1, data was recorded, and the data was reproduced in the same way as that in Example 1. The optimal laser beam power was 7.0 mW.

Next, the data recorded in the optical recording medium sample #14 was reproduced using the above-mentioned data recording/reproducing apparatus by fixing the power of the laser beam to 0.35 mW, and the reproduction signal was evaluated. The DC jitter was 8.0%, the degree of modulation was 41%, and the asymmetry was 1.2%.

### Example 15

An optical recording medium sample #15 was prepared in the same way as that in Example 1 except that instead of the organic dye having the structure represented by the structural formula (31), an organic dye having the structure represented by the following structural formula (45) and a decomposition starting temperature of 233° C. was used.

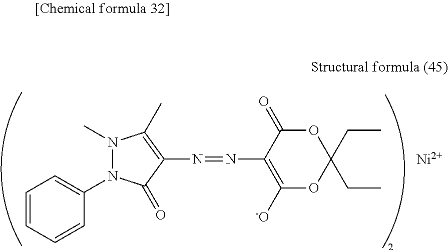

The absorption maximum wavelength λmax of the optical recording medium sample #15 was 401 nm, and the OD value was 0.22.

The optical recording medium sample #15 prepared in this way was set in the data recording/reproducing apparatus used in Example 1, data was recorded, and the data was reproduced in the same way as that in Example 1. The optimal laser beam power was 7.8 mW.

Next, the data recorded in the optical recording medium sample #15 was reproduced using the above-mentioned data recording/reproducing apparatus by fixing the power of the laser beam to 0.35 mW, and the reproduction signal was evaluated. The DC jitter was 9.1%, the degree of modulation was 44%, and the asymmetry was 4.2%.

### Example 16

An optical recording medium sample #16 was prepared in the same way as that in Example 1 except that a light transmission layer having a thickness of 0.1 mm and a modulus of elasticity of 45 MPa at a temperature of 25° C. was formed by applying ultraviolet curable resin to the surface of the protective layer by a spin coating method to form a coating film, and applying ultraviolet rays to the coating film to cure the coating film.

The absorption maximum wavelength λmax of the optical recording medium sample #16 was 379 nm, and the OD value was 0.25.

The optical recording medium sample #16 prepared in this way was set in the data recording/reproducing apparatus used in Example 1, data was recorded, and the data was reproduced in the same way as that in Example 1. The optimal laser beam power was 8.6 mW.

Next, the data recorded in the optical recording medium sample #16 was reproduced using the above-mentioned data recording/reproducing apparatus by fixing the power of the laser beam to 0.35 mW, and the reproduction signal was evaluated. The DC jitter was 7.8%, the degree of modulation was 42%, and the asymmetry was 4.0%.

### Example 17

An optical recording medium sample #17 was prepared in the same way as that in Example 1 except that a light transmission layer having a thickness of 0.1 mm and a modulus of elasticity of 270 MPa at a temperature of 25° C. was formed by applying ultraviolet curable resin to the surface of the protective layer by a spin coating method to form a coating film, and applying ultraviolet rays to the coating film to cure the coating film.

The absorption maximum wavelength λmax of the optical recording medium sample #17 was 379 nm, and the OD value was 0.25.

The optical recording medium sample #17 prepared in this way was set in the data recording/reproducing apparatus used in Example 1, data was recorded, and the data was reproduced in the same way as that in Example 1. The optimal laser beam power was 8.6 mW.

Next, the data recorded in the optical recording medium sample #17 was reproduced using the above-mentioned data recording/reproducing apparatus by fixing the power of the laser beam to 0.35 mW, and the reproduction signal was evaluated. The DC jitter was 7.9%, the degree of modulation was 44%, and the asymmetry was 5.2%.

### Example 18

An optical recording medium sample #18 was prepared in the same way as that in Example 1 except that a light transmission layer having a thickness of 0.1 mm and a modulus of elasticity of 690 MPa at a temperature of 25° C. was formed by applying ultraviolet curable resin to the surface of the protective layer by a spin coating method to form a coating film, and applying ultraviolet rays to the coating film to cure the coating film.

The absorption maximum wavelength λmax of the optical recording medium sample #18 was 379 nm, and the OD value was 0.25.

The optical recording medium sample #18 prepared in this way was set in the data recording/reproducing apparatus used in Example 1, data was recorded, and the data was reproduced in the same way as that in Example 1. The optimal laser beam power was 8.6 mW.

Next, the data recorded in the optical recording medium sample #18 was reproduced using the above-mentioned data recording/reproducing apparatus by fixing the power of the laser beam to 0.35 mW, and the reproduction signal was evaluated. The DC jitter was 7.7%, the degree of modulation was 45%, and the asymmetry was 5.7%.

### Example 19

An optical recording medium sample #19 was prepared in the same way as that in Example 1 except that a light transmission layer having a thickness of 0.1 mm and a modulus of elasticity of 1200 MPa at a temperature of 25° C. was formed by applying ultraviolet curable resin to the surface of the protective layer by a spin coating method to form a coating film, and applying ultraviolet rays to the coating film to cure the coating film.

The absorption maximum wavelength λmax of the optical recording medium sample #19 was 379 nm, and the OD value was 0.25.

The optical recording medium sample #19 prepared in this way was set in the data recording/reproducing apparatus used in Example 1, data was recorded, and the data was reproduced in the same way as that in Example 1. The optimal laser beam power was 8.6 mW.

Next, the data recorded in the optical recording medium sample #19 was reproduced using the above-mentioned data recording/reproducing apparatus by fixing the power of the laser beam to 0.35 mW, and the reproduction signal was evaluated. The DC jitter was 8.1%, the degree of modulation was 48%, and the asymmetry was 4.2%.

### Example 20

An optical recording medium sample #20 was prepared in the same way as that in Example 1 except that a light transmission layer having a thickness of 0.1 mm and a modulus of elasticity of 3100 MPa at a temperature of 25° C. was formed by applying ultraviolet curable resin to the surface of the protective layer by a spin coating method to form a coating film, and applying ultraviolet rays to the coating film to cure the coating film.

The absorption maximum wavelength λmax of the optical recording medium sample #20 was 379 nm, and the OD value was 0.25.

The optical recording medium sample #20 prepared in this way was set in the data recording/reproducing apparatus used in Example 1, data was recorded, and the data was reproduced in the same way as that in Example 1. The optimal laser beam power was 8.6 mW.

Next, the data recorded in the optical recording medium sample #20 was reproduced using the above-mentioned data recording/reproducing apparatus by fixing the power of the laser beam to 0.35 mW, and the reproduction signal was evaluated. The DC jitter was 8.3%, the degree of modulation was 42%, and the asymmetry was 3.8%.

### Example 21

An optical recording medium sample #21 was prepared in the same way as that in Example 15 except that a light transmission layer having a thickness of 0.1 mm and a modulus of elasticity of 45 MPa at a temperature of 25° C. was formed by applying ultraviolet curable resin to the surface of the protective layer by a spin coating method to form a coating film, and applying ultraviolet rays to the coating film to cure the coating film.

The absorption maximum wavelength λmax of the optical recording medium sample #21 was 401 nm, and the OD value was 0.22.

The optical recording medium sample #21 prepared in this way was set in the data recording/reproducing apparatus used in Example 1, data was recorded, and the data was reproduced in the same way as that in Example 1. The optimal laser beam power was 7.8 mW.

Next, the data recorded in the optical recording medium sample #21 was reproduced using the above-mentioned data recording/reproducing apparatus by fixing the power of the laser beam to 0.35 mW, and the reproduction signal was evaluated. The DC jitter was 8.8%, the degree of modulation was 41%, and the asymmetry was 3.9%.

### Example 22

An optical recording medium sample #22 was prepared in the same way as that in Example 15 except that a light transmission layer having a thickness of 0.1 mm and a modulus of elasticity of 270 MPa at a temperature of 25° C. was formed by applying ultraviolet curable resin to the surface of the protective layer by a spin coating method to form a coating film, and applying ultraviolet rays to the coating film to cure the coating film.

The absorption maximum wavelength λmax of the optical recording medium sample #22 was 401 nm, and the OD value was 0.22.

The optical recording medium sample #22 prepared in this way was set in the data recording/reproducing apparatus used in Example 1, data was recorded, and the data was reproduced in the same way as that in Example 1. The optimal laser beam power was 7.8 mW.

Next, the data recorded in the optical recording medium sample #22 was reproduced using the above-mentioned data recording/reproducing apparatus by fixing the power of the laser beam to 0.35 mW, and the reproduction signal was evaluated. The DC jitter was 9.1%, the degree of modulation was 42%, and the asymmetry was 4.6%.

### Example 23

An optical recording medium sample #23 was prepared in the same way as that in Example 15 except that a light transmission layer having a thickness of 0.1 mm and a modulus of elasticity of 1200 MPa at a temperature of 25° C. was formed by applying ultraviolet curable resin to the surface of the protective layer by a spin coating method to form a coating film, and applying ultraviolet rays to the coating film to cure the coating film.

The absorption maximum wavelength λmax of the optical recording medium sample #23 was 401 nm, and the OD value was 0.22.

The optical recording medium sample #23 prepared in this way was set in the data recording/reproducing apparatus used in Example 1, data was recorded, and the data was reproduced in the same way as that in Example 1. The optimal laser beam power was 7.8 mW.

Next, the data recorded in the optical recording medium sample #23 was reproduced using the above-mentioned data recording/reproducing apparatus by fixing the power of the laser beam to 0.35 mW, and the reproduction signal was evaluated. The DC jitter was 9.3%, the degree of modulation was 45%, and the asymmetry was 6.2%.

### Example 24

An optical recording medium sample #24 was prepared in the same way as that in Example 15 except that a light transmission layer having a thickness of 0.1 mm and a modulus of elasticity of 3100 MPa at a temperature of 25° C. was formed by applying ultraviolet curable resin to the surface of the protective layer by a spin coating method to form a coating film, and applying ultraviolet rays to the coating film to cure the coating film.

The absorption maximum wavelength λmax of the optical recording medium sample #24 was 401 nm, and the OD value was 0.22.

The optical recording medium sample #24 prepared in this way was set in the data recording/reproducing apparatus used in Example 1, data was recorded, and the data was reproduced in the same way as that in Example 1. The optimal laser beam power was 7.8 mW.

Next, the data recorded in the optical recording medium sample #24 was reproduced using the above-mentioned data recording/reproducing apparatus by fixing the power of the laser beam to 0.35 mW, and the reproduction signal was evaluated. The DC jitter was 9.2%, the degree of modulation was 43%, and the asymmetry was 4.7%.

### Comparative Example 1

An optical recording medium comparative sample #1 was prepared in the same way as that in Example 1 except that a recording layer was formed by using an organic dye having the structure represented by the structural formula (51) and a decomposition starting temperature of 245° C. instead of the organic dye having the structure represented by the structural formula (31), and a light transmission layer having a thickness of 0.1 mm and a modulus of elasticity of 45 MPa at a temperature of 25° C. was formed by applying ultraviolet curable resin to the surface of the protective layer by a spin coating method to form a coating film, and applying ultraviolet rays to the coating film to cure the coating film.

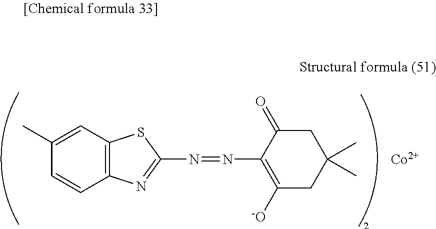

The absorption maximum wavelength λmax of the optical recording medium comparative sample #1 was 482 nm, and the OD value was 0.31.

The optical recording medium comparative sample #1 prepared in this way was set in the data recording/reproducing apparatus used in Example 1, data was recorded, and the data was reproduced in the same way as that in Example 1. The optimal laser beam power was 9.7 mW.

Next, the data recorded in the optical recording medium comparative sample #1 was reproduced using the above-mentioned data recording/reproducing apparatus by fixing the power of the laser beam to 0.35 mW, and the reproduction signal was evaluated. The DC jitter was 23.4%, the degree of modulation was 31%, and the asymmetry was 38.9%.

### Comparative Example 2

An optical recording medium comparative sample #2 was prepared in the same way as that in Example 1 except that a recording layer was formed by using an organic dye having the structure represented by the structural formula (52) and a decomposition starting temperature of 272° C. instead of the organic dye having the structure represented by the structural formula (31), and a light transmission layer having a thickness of 0.1 mm and a modulus of elasticity of 45 MPa at a temperature of 25° C. was formed by applying ultraviolet curable resin to the surface of the protective layer by a spin coating method to form a coating film, and applying ultraviolet rays to the coating film to cure the coating film.

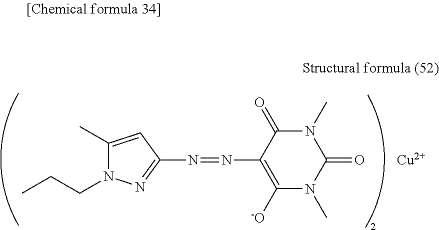

The absorption maximum wavelength λmax of the optical recording medium comparative sample #2 was 415 nm, and the OD value was 0.27.

The optical recording medium comparative sample #2 prepared in this way was set in the data recording/reproducing apparatus used in Example 1, data was recorded, and the data was reproduced in the same way as that in Example 1. The optimal laser beam power was 8.8 mW.

Next, the data recorded in the optical recording medium comparative sample #2 was reproduced using the above-mentioned data recording/reproducing apparatus by fixing the power of the laser beam to 0.35 mW, and the reproduction signal was evaluated. The DC jitter was 24.5%, the degree of modulation was 42%, and the asymmetry was 40.0%.

### Comparative Example 3

An optical recording medium comparative sample #3 was prepared in the same way as that in Example 1 except that a recording layer was formed by using an organic dye having the structure represented by the structural formula (53) and a decomposition starting temperature of 332° C. instead of the organic dye having the structure represented by the structural formula (31), and a light transmission layer having a thickness of 0.1 mm and a modulus of elasticity of 45 MPa at a temperature of 25° C. was formed by applying ultraviolet curable resin to the surface of the protective layer by a spin coating method to form a coating film, and applying ultraviolet rays to the coating film to cure the coating film.

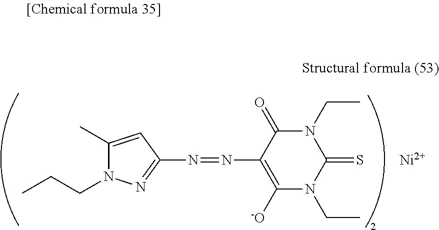

The absorption maximum wavelength λmax of the optical recording medium comparative sample #3 was 430 nm, and the OD value was 0.30.

The optical recording medium comparative sample #3 prepared in this way was set in the data recording/reproducing apparatus used in Example 1, data was recorded, and the data was reproduced in the same way as that in Example 1. The optimal laser beam power was 9.8 mW.

Next, the data recorded in the optical recording medium comparative sample #3 was reproduced using the above-mentioned data recording/reproducing apparatus by fixing the power of the laser beam to 0.35 mW, and the reproduction signal was evaluated. The DC jitter was 24.9%, the degree of modulation was 53%, and the asymmetry was 44.8%.

### Comparative Example 4

An optical recording medium comparative sample #4 was prepared in the same way as that in Example 1 except that a recording layer was formed by using an organic dye having the structure represented by the structural formula (54) and a decomposition starting temperature of 341° C. instead of the organic dye having the structure represented by the structural formula (31), and a light transmission layer having a thickness of 0.1 mm and a modulus of elasticity of 45 MPa at a temperature of 25° C. was formed by applying ultraviolet curable resin to the surface of the protective layer by a spin coating method to form a coating film, and applying ultraviolet rays to the coating film to cure the coating film.

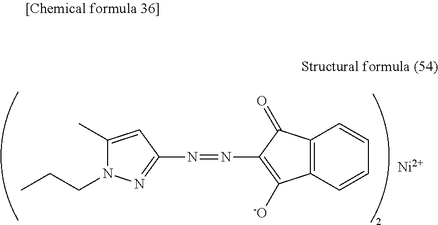

The absorption maximum wavelength λmax of the optical recording medium comparative sample #4 was 444 nm, and the OD value was 0.27.

The optical recording medium comparative sample #4 prepared in this way was set in the data recording/reproducing apparatus used in Example 1, data was recorded, and the data was reproduced in the same way as that in Example 1. The optimal laser beam power was 9.5 mW.

Next, the data recorded in the optical recording medium comparative sample #4 was reproduced using the above-mentioned data recording/reproducing apparatus by fixing the power of the laser beam to 0.35 mW, and the reproduction signal was evaluated. The DC jitter was 22.5%, the degree of modulation was 40%, and the asymmetry was 29.1%.

### Comparative Example 5

An optical recording medium comparative sample #4 was prepared in the same way as that in Example 1 except that a recording layer was formed by using an organic dye having the structure represented by the structural formula (55) and a decomposition starting temperature of 266° C. instead of the organic dye having the structure represented by the structural formula (31), and a light transmission layer having a thickness of 0.1 mm and a modulus of elasticity of 45 MPa at a temperature of 25° C. was formed by applying ultraviolet curable resin to the surface of the protective layer by a spin coating method to form a coating film, and applying ultraviolet rays to the coating film to cure the coating film.

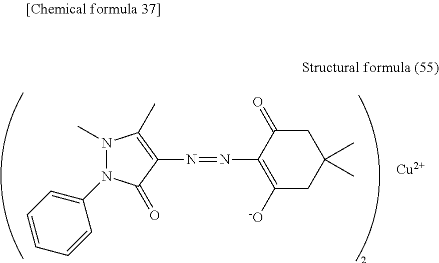

The absorption maximum wavelength λmax of the optical recording medium comparative sample #4 was 432 nm, and the OD value was 0.27.

The optical recording medium comparative sample #4 prepared in this way was set in the data recording/reproducing apparatus used in Example 1, data was recorded, and the data was reproduced in the same way as that in Example 1. The optimal laser beam power was 9.3 mW.

Next, the data recorded in the optical recording medium comparative sample #4 was reproduced using the above-mentioned data recording/reproducing apparatus by fixing the power of the laser beam to 0.35 mW, and the reproduction signal was evaluated. The DC jitter was 23.2%, the degree of modulation was 33%, and the asymmetry was 27.2%.

From Examples 1 to 24 and Comparative Examples 1 to 5, it turned out that the optical recording medium samples #1 to #24 in which the recording layer was formed using the organic dye having a decomposition starting temperature of 233° C. or less had favorable recording/reproduction properties, i.e., the DC jitter of less than 10%, the degree of modulation of 40% or more, and the asymmetry in the reproduction signal of 9.5% or less, and that the optical recording medium comparative samples #1 to #5 in which the recording layer was formed using the organic dye having a decomposition starting temperature of 245° C. or more had extremely bad recording/reproduction properties, i.e., the DC jitter of more than 22.5% and the asymmetry in the reproduction signal of much more than 15% in all the comparative samples, and the degree of modulation of less than 40% in the optical recording medium comparative sample #1.

Moreover, from Examples 1 to 24, it turned out that the optical recording medium samples #1 to #24 in which the recording layer was formed using the organic dye having a decomposition starting temperature of 233° C. or less had favorable recording/reproduction properties even if a single-layered light transmission layer is formed of photo-curable resin having a modulus of elasticity of 45 MPa or more at a temperature of 25° C., and thus the light transmission layer can have a single-layered configuration. On the other hand, from Comparative Examples 1 to 5, it turned out that because the optical recording medium comparative samples #1 to #5 in which a single-layered light transmission layer is formed of photo-curable resin having a modulus of elasticity of 45 MPa or more at a temperature of 25° C. and the recording layer was formed using the organic dye having a decomposition starting temperature of 245° C. or more had extremely bad recording/reproduction properties, i.e., an extremely high asymmetry in the reproduction signal, it was impossible to form the light transmission layer to have a single-layered configuration.

The present invention is not limited to the above-mentioned embodiments and various modifications can be made within the scope of the invention as defined by the claims, which are also included within the scope of the present invention.

For example, in the embodiments and Examples, the recording layer is formed of one kind of organic dye. However, it does not necessarily need to form the recording layer by one kind of organic dye, and the recording layer may be formed by a mixture of two or more kinds of organic dyes. Furthermore, the mixture of the organic dyes forming the recording layer may contain an organic dye having a decomposition starting temperature of more than 240° C. as long as the decomposition starting temperature of the entire mixture of the organic dyes is 240° C. or less.

Furthermore, in the embodiments, the optical recording medium 1 is formed by the substrate 10 on which the reflective layer 11, the recording layer 12, the protective layer 13, the light transmission layer 14, and the hard coating layer 15 are laminated in the stated order. The optical recording medium 1 does not necessarily need to have such a configuration, and a protective layer formed of a dielectric may be provided between the recording layer 12 and the reflective layer 11.

### DESCRIPTION OF SYMBOLS

1 recordable optical recording medium
5 laser beam
10 substrate
10a guide groove formed in substrate
11 reflective layer
11a guide groove formed in reflective layer
12 recording layer
13 protective layer
14 light transmission layer
15 hard coating layer

1. A recordable optical recording medium, comprising
a substrate on which at least a reflective layer, a recording layer containing an organic dye, and a single-layered light transmission layer are laminated, characterized in that
the organic dye has a decomposition starting temperature of 240° C. or less.

2. The recordable optical recording medium according to claim 1, characterized in that
as the organic dye having a decomposition starting temperature of 240° C. or less, a metal complex compound configured by bonding an azo compound having a specific structure represented by the following general formula (1) to a metal ion to form a coordinate bond is used: 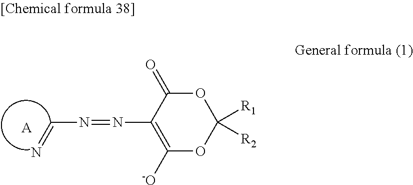
(in the general formula (1), a nucleus A represents a nitrogen-containing heteroaromatic ring, and R1 and R2 each represent an alkyl group that may be substituted, which has 1 to 10 carbon atoms, and may form a linear alkyl group, a branched alkyl group, or a cyclic structure).

3. The recordable optical recording medium according to claim 1, characterized in that
as the organic dye having a decomposition starting temperature of 240° C. or less, a metal complex compound configured by bonding an azo compound having a specific structure represented by the following general formula (2) to a metal ion to form a coordinate bond is used: 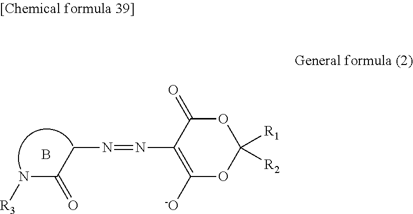
(in the general formula (2), a nucleus B represents a nitrogen-containing heteroaromatic ring, R1 and R2 each represent an alkyl group that may be substituted, which has 1 to 10 carbon atoms, and may form a linear alkyl group, a branched alkyl group, or a cyclic structure, and R3 represents an aromatic group or an alkyl group having 1 to 6 carbon atoms, and may form a linear alkyl group, a branched alkyl group, or a cyclic structure).

4. The recordable optical recording medium according to claim 1, characterized in that
the metal ion to which the azo compound having a specific structure represented by the general formula (1) is coordinated is selected from the metal group consisting of nickel, cobalt, and copper.

5. The recordable optical recording medium according to claim 1, characterized in that
the metal ion to which the azo compound having a specific structure represented by the general formula (2) is coordinated is selected from the metal group consisting of nickel, cobalt, and copper.

6. The recordable optical recording medium according to claim 1, characterized in that
the nucleus A being a nitrogen-containing heteroaromatic ring in the formula (1) is selected from the group consisting of nitrogen-containing heteroaromatic rings represented by the following structural formulae (11) to (24): 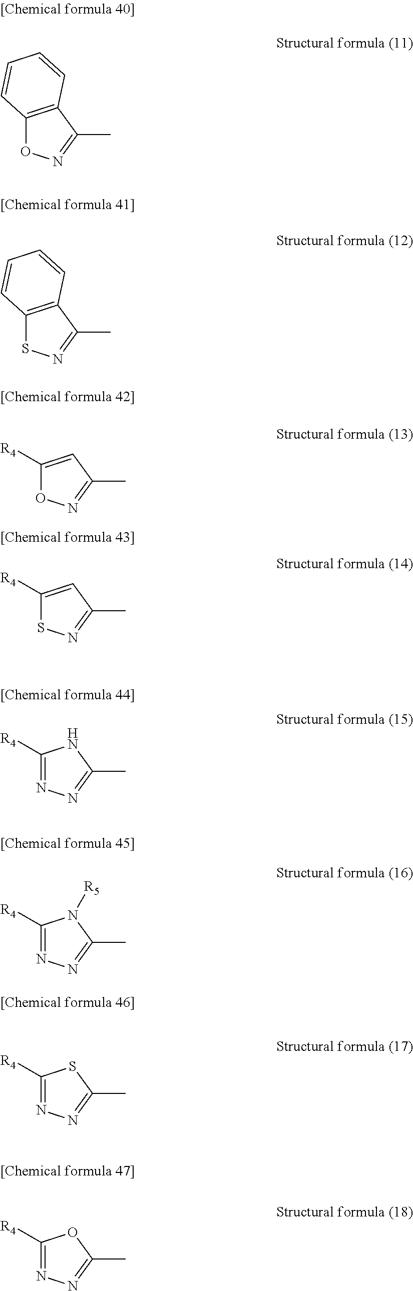 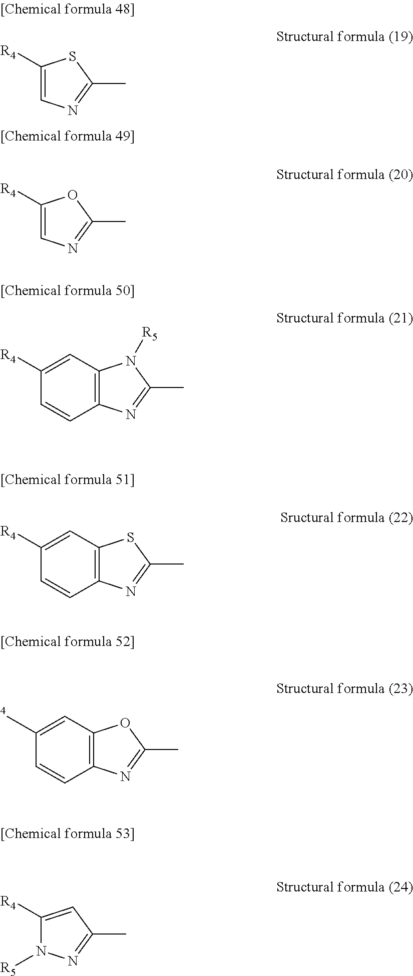
(in the structural formulae (13) to (24), R4 and R5 each represent a hydrogen atom, an alkyl group having 1 to 6 carbon atoms, a benzyl group, alkoxy group having 1 to 4 carbon atoms, or a thioalkyl group having 1 to 4 carbon atoms, and the alkyl group may form a linear alkyl group, a branched alkyl group, or a cyclic structure).

7. The recordable optical recording medium according to claim 1, characterized in that
the nucleus B being a nitrogen-containing heteroaromatic ring in the formula (2) has a structure represented by the following structural formula (25):

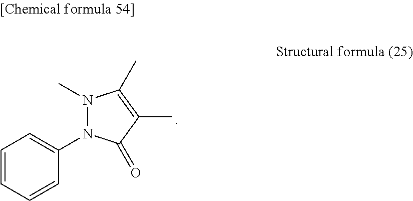

8. The recordable optical recording medium according to claim 1, characterized in that
the single-layered light transmission layer is formed of photo-curable resin having a modulus of elasticity of 10 MPa or more at a temperature of 25° C.

9. The recordable optical recording medium according to claim 8, characterized in that
the single-layered light transmission layer is formed of photo-curable resin having a modulus of elasticity of 40 MPa to 10000 MPa or more at a temperature of 25° C.

10. The recordable optical recording medium according to claim 1, characterized by further comprising
a protective layer formed of a dielectric material between the recording layer and the light transmission layer.

11. The recordable optical recording medium according to claim 1, characterized by further comprising
a hard coating layer on a surface of the light transmission layer, the surface being opposite to the recording layer.
